(19) United States
(12) Patent Application Publication
(10) Pub. No.: US 2023/0160404 A1
(43) Pub. Date: May 25, 2023

(54) POROUS FLOW RESTRICTOR AND METHODS OF MANUFACTURE THEREOF

(71) Applicant: Mott Corporation, Farmington, CT (US)

(72) Inventors: Alex Hill, South Windsor, CT (US); Allen L. Beaune, Norfolk, CT (US); Aravind Mohanram, Avon, CT (US)

(21) Appl. No.: 17/991,066

(22) Filed: Nov. 21, 2022

Related U.S. Application Data
(60) Provisional application No. 63/282,011, filed on Nov. 22, 2021.

(51) Int. Cl. F15D 1/02; C04B 35/10; C04B 35/64; C04B 38/02; C04B 38/06

(52) U.S. Cl. CPC F15D 1/025; C04B 35/10; C04B 35/64; C04B 38/02; C04B 38/067; C04B 2235/612; C04B 2235/656; C04B 2235/945; C04B 2235/3217

(57) ABSTRACT

Disclosed herein is a dual density disc comprising a dense outer tube comprising a metal oxide having a purity of greater than 92%; and a porous core comprising a metal oxide of a lower density than a density of the dense outer tube; wherein the porous core has a metal oxide purity of greater than 99%; where the dense outer tube has an inner tapered surface.

### CROSS REFERENCE TO RELATED APPLICATIONS

This application claims the benefit of U.S. Application No. 63/282,011, filed on Nov. 22, 2021 which is incorporated herein by reference in its entirety.

### BACKGROUND

This disclosure relates to porous flow restrictors and methods of manufacture thereof.

### SUMMARY

Disclosed herein is a dual density disc comprising a dense outer tube comprising a metal oxide having a purity of greater than 90%; and a porous core comprising a metal oxide of a lower density than a density of the dense outer tube; wherein the porous core has a metal oxide purity of greater than 90%; where the dense outer tube has an inner threaded surface.

Disclosed herein is a method comprising disposing in a dense outer tube a slurry comprising a metal oxide powder and a pore former; heating the dense outer tube with the slurry disposed therein to a temperature of 300 to 600° C. to activate the pore former; creating a porous core in the dense outer tube; sintering the dense outer tube with the porous core at a temperature of 800 to 2000° C. in one or more steps; and machining threads on an inner surface of the dense outer tube, where the threads are parallel to a longitudinal axis of the tube or inclined to the longitudinal axis of the tube.

Disclosed herein too is a method comprising disposing into a dense outer tube an alumina powder; where the aluminum powder does not contain a pore former; sintering the dense outer tube with the alumina powder disposed therein to a temperature of 800 to 2000° C.; creating a porous core in the dense outer tube; where the porous core has a purity of greater than 99%; and machining threads on an inner surface of the dense outer tube; where the threads are parallel to a longitudinal axis of the tube or inclined to the longitudinal axis of the tube.

Disclosed herein too is a dual density disc comprising a dense outer tube comprising a first ceramic having a purity of greater than 96%; a porous core comprising a second ceramic of a lower density than a density of the dense outer tube; wherein the porous core has a purity of greater than 99%; and wherein the dense outer tube comprises threads on an inner surface of the dense outer tube; where the threads are parallel to a longitudinal axis of the tube or inclined to the longitudinal axis of the tube.

### BRIEF DESCRIPTION OF THE FIGURES

The patent or application file contains at least one drawing executed in color. Copies of this patent or patent application publication with color drawing(s) will be provided by the Office upon request and payment of the necessary fee.

FIG. 1A is an exemplary schematic depiction of one embodiment of a dense outer tube with a porous metal oxide interior;

FIG. 1B is an exemplary schematic depiction of another embodiment of a dense outer tube with a porous metal oxide interior; and

FIG. 1C is an exemplary schematic depiction of another embodiment of a dense outer tube with a porous metal oxide interior.

### DETAILED DESCRIPTION

Disclosed herein is a porous flow restrictor that comprises a ceramic plug with a porous interior. The porous interior regulates the flow of fluid while maintaining sufficient electrical insulation and dielectric strength to prevent ionization of the aforementioned fluid when exposed to high electrical potentials across the length of the restrictor. In one embodiment, the porous interior contains grooves or threads along the interface between the porous interior and the solid shell. In another embodiment, the interior porous comprises a taper as depicted in the accompanying figures. The taper contains threads on its surface. The ceramic plug is a dual density disc comprising of a dense outer tube comprising a metal oxide having a purity of greater than 90%, preferably greater than 92%, preferably greater than 96%; and a porous core comprising a metal oxide of a lower density than a density of the dense outer tube; wherein the porous core has a metal oxide purity of greater than 90%, preferably greater than 92%, and more preferably greater than 99%. In an embodiment, the metal oxide is alumina. The alumina dense outside tube has a purity of greater than 92%, preferably greater than 96%, while the porous alumina core has a purity of greater than 99%.

Disclosed herein too is method comprising disposing in a dense outer tube a slurry comprising a metal oxide, a powder and a pore former; heating the dense outer tube with the slurry disposed therein to a temperature of 100 to 600° C. to activate the pore former; creating a porous core in the dense outer tube; and sintering the dense outer tube with the porous core at a temperature of 800° C. to 2000° C. in one or more stages. The threads can be machined in the dense outer tube before or after the disposing of the powder into the dense outer tube. In a preferred embodiment, the threads are machined after the dense outer shell is manufactured and prior to disposing the powder in the dense outer shell.

In an embodiment, a method for manufacturing the metal oxide disc comprises disposing into a dense outer tube a metal oxide powder. No pore former and/or solvent is used in the powder. The dense outer tube with the metal oxide powder disposed therein to a temperature of 800 to 2000° C. in one or more steps. This creates a porous core in the dense outer tube that has a purity of greater than 99%. Both the porous core and the dense outer tube have a purity of greater than 99%.

Disclosed herein is a dual density disc comprising a dense outer tube comprising a first ceramic having a purity of greater than 96%; and a porous core comprising a second ceramic of a lower density than a density of the dense outer tube; wherein the porous core has a purity of greater than 99%. In an embodiment, the first ceramic may be the same as the second ceramic. In another embodiment, the first ceramic may be different from the second ceramic.

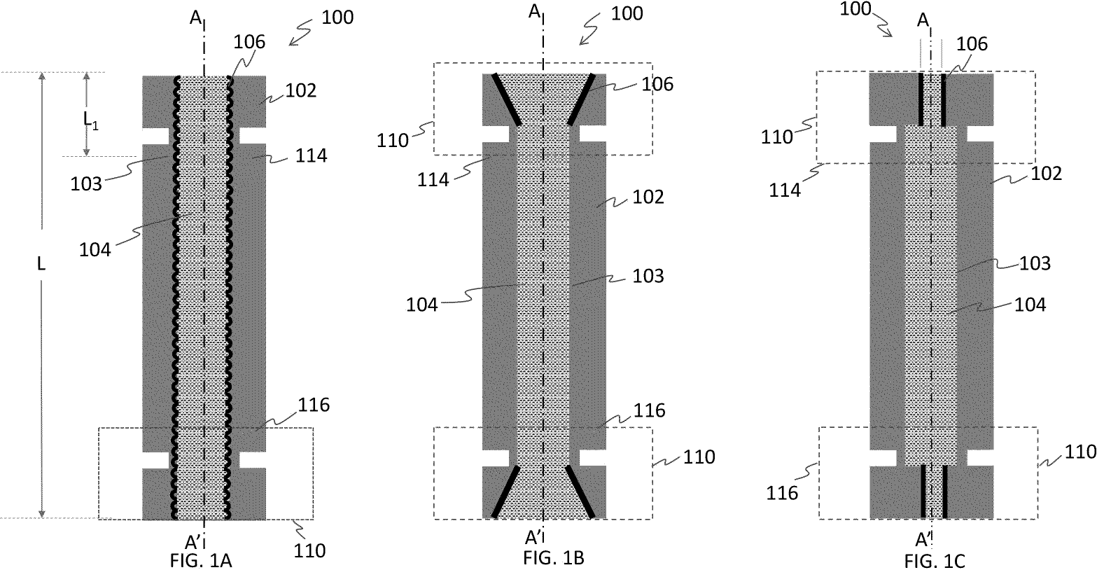

FIG. 1A, FIG. 1B and FIG. 1C depict the ceramic plug 100, which comprises a dense outer tube 102 and a porous central region 104 that is encompassed by the dense outer tube 102. The outer surface of the porous central region 102 contacts an inner surface of the dense outer tube 102 at its periphery 103. Threads 106 are disposed on the inner surface of the dense outer tube 102. The threads may be parallel to a longitudinal axis AA′ of the tube or inclined to the longitudinal axis of the tube. The threads are located at an inlet, an outlet or at both the inlet and the outlet of the tube.

FIG. 1A depicts the ceramic plug 100 having a dense outer tube 102 and a porous central region 104 where the porous central region 104 contacts an inner surface 106 of the dense outer tube 102. The inner surface 106 (of the dense outer tube 102) has threads machined thereon. The threads may be machined on the entire inner surface of length L as shown in the FIG. 1A or alternatively, be machines only on the inner surface for a length L₁. Length L₁ represents the length of the sleeve 110. The sleeve 110 is monolithic with the rest of the ceramic plug 100 and offers better alignment, reduction in gaps and improved overall performance. As may be seen the ceramic plug 100 comprises two opposing sleeves 110 at opposite ends of the plug.

FIG. 1B depicts a tapered sleeve 112 that is disposed at opposing of the ceramic plug 100. The tapered sleeve 112 may or may not contain tapered threads machined on an inner surface 106 of the dense outer tube 102. The dense outer tube 102 in this case also contains the porous central region 104.

The porous central region may extend along the entire length L of the ceramic plug 100 or alternatively, may extend from a first end of the sleeve 114 to a second end of the sleeve 116 for a total length of L-2L₁. The inlet diameter or outlet diameter is greater than a diameter in a central region of the ceramic plug 100.

FIG. 1C depicts a ceramic plug 100 with an inlet port and an outlet port that has a narrower diameter than a diameter of the central portion of the ceramic plug. As with FIGS. 1A and 1B, the dense outer tube 102 contains a porous central region 104, where the porous central region 104 contacts an inner surface 106 of the dense outer tube 102. The dense outer tube 102 has a larger inner diameter d1 than a diameter d2 at an inlet or at an outlet of the ceramic plug 100. In an embodiment, there is a step in the diameter between the inlet diameter and the central region of the ceramic plug 100. In another embodiment, there is a step in the diameter between the outlet diameter and the central region of the ceramic plug 100. The inlet and outlet of the ceramic plug have threads 106 optionally disposed on their respective inner surfaces.

The dense outer tube has a high strength that is provided by a dense ceramic shell (hereinafter dense shell). The dense shell surrounds the largely porous ceramic core (hereinafter porous core) that permits uniform gas flow during manufacturing operations (such as for making semiconductor wafers). The dense ceramic shell has a high purity of greater than 96% and this prevents contamination of the semiconductor parts during a manufacturing operation that deploys the ceramic disc. The porous core contacts the dense ceramic shell at its inner surface and the outer tube is in continuous contact with the porous core along an entire circumference of the porous core. In an embodiment, the porous core contains the same chemical composition as the dense shell except that the core is porous while the shell is dense. The density of the shell is greater than that of the porous core.

In another embodiment, the porous core contains a ceramic that has a different chemical composition from that of the dense shell. Disclosed herein is a dual density disc comprising a dense outer tube comprising a first ceramic having a purity of greater than 96%; and a porous core comprising a second ceramic of a lower density than a density of the dense outer tube; wherein the porous core has a purity of greater than 99%. In an embodiment, the first ceramic may be the same as the second ceramic. In another embodiment, the first ceramic may be different from the second ceramic.

The ceramic used in the disc comprises an oxide, a carbide, an oxycarbide, a nitride, an oxynitride, a boride, a borocarbide, a boronitride, a silicide, an iodide, a bromide, a sulfide, a selenide, a telluride, a fluoride, or a borosilicide of a metal. Suitable metals are aluminum, titanium, zirconium, silicon, cerium, or the like, or combinations thereof.

In an embodiment, the ceramic is preferably a metal oxide. Preferred metal oxides are titania, silica, alumina, zirconia, ceria, or the like, or a combination thereof. A preferred metal oxide for use in the disc is alumina. While the article and the method of manufacture detailed below are directed to alumina discs, they can equally apply to any of the ceramics listed above. The temperatures and atmosphere listed for manufacturing the alumina disc below work equally well for any of the ceramics listed above and hence there will be no repetition of the annealing temperatures, sintering temperatures or of the atmosphere and pressures used for manufacturing the ceramic disc.

Disclosed herein too are alumina discs or rods (hereinafter termed a “disc”) having a dual density that comprises a dense shell and a porous core (of lower density than the shell) that is used for providing uniform gas flow for semiconductor manufacturing operations. The rod may be sliced into a number of smaller slices called discs. The disc has a high strength that is provided by the dense shell. The dense shell surrounds the largely porous core that permits uniform gas flow during manufacturing operations (for making semiconductors). In addition, the disc contains alumina having a high purity of greater than 96% and this prevents contamination of the semiconductor parts during a manufacturing operation that deploys the alumina disc. The porous core contacts the dense outer tube (the shell) at its inner surface and the outer tube is in continuous contact with the porous core along an entire circumference of the porous core. This core-shell dual density structure provides radial hermiticity (i.e. prevent leaks from the sides of the porous body) and allows flow only through longitudinal direction. It is to be noted that the outer shell is referred to herein as the “alumina shell”, “alumina tube”, the “dense shell” and the “dense outer tube”. Each disc has threads (as described above) machined on its opposing ends.

Disclosed herein too is a method for manufacturing the alumina disc or rod. The method comprises filling a dense alumina tube with an alumina slurry. The alumina slurry contains alumina powder (of a high purity) and a pore former. The tube with the slurry contained therein is then fired to produce the porous core in the dense alumina tube. The alumina tube with the porous core may then be subjected to finishing operations such as slicing, lapping, grinding, and the like, to produce the alumina disc. The alumina slurry may be in dry (without the presence of a liquid such as a solvent) or in wet form.

The porous core is manufactured by filling the hollow central portion of the alumina tube with a metal oxide slurry or powder (e.g., alumina slurry or powder) and then heating the tube with the slurry or powder contained therein to form the metal oxide (e.g., alumina) disc. The slurry comprises a metal oxide powder (e.g., an alumina powder) having a high purity, an optional solvent and a pore former. These are detailed below.

The porous core may also be formed without the use of a pore former and a solvent. The distribution in particle sizes may produce the porous core when sintering is formed. Neighboring portions of the particles undergo necking as they bond with each other to form the porous core.

Metal oxide (e.g., alumina) powder having either narrow particle size distribution or a wide particle size distribution is formed into a slurry with a solvent and a pore former. The alumina powder can have particles sizes of 10 nanometers to 500 micrometers, preferably 100 nanometers to 150 micrometers, and more preferably 150 nanometers to 100 micrometers. The alumina powder can have a unimodal distribution of particle sizes or alternatively can have a bimodal or greater distribution of particle sizes.

The metal oxide (e.g., alumina) powder also has a purity of greater than 99% and preferably greater than 99.3%. The metal oxide (e.g., alumina) powder may be present in the slurry in an amount of 10 to 90 wt%, preferably 20 to 60 wt%, based on the total weight of the slurry.

The solvent is optional. The solvent used for forming the slurry may include polar or non-polar solvents. Solvents may be protic or aprotic. Liquid aprotic polar solvents such as propylene carbonate, ethylene carbonate, butyrolactone, acetonitrile, benzonitrile, nitromethane, nitrobenzene, sulfolane, dimethylformamide, N— methylpyrrolidone, or the like, or combinations thereof are generally desirable. Polar protic solvents such as, but not limited to, water, methanol, acetonitrile, nitromethane, ethanol, propanol, isopropanol, butanol, or the like, or combinations thereof may be used. Other non-polar solvents such a benzene, toluene, carbon tetrachloride, hexane, diethyl ether, tetrahydrofuran, or the like, or combinations thereof may also be used. A suitable solvent is water, alcohol, or a combination thereof.

When present, the solvent may be used in amounts of 5 to 80 wt%, preferably 15 to 60 wt%, based on the total weight of the slurry.

The pore former is optional. A pore former may (or may not) be mixed into the slurry to facilitate the formation of a porous core in the metal oxide (e.g., alumina) tube. As noted above, the distribution in particle sizes may give rise to the porosity present in the core (when a solvent or a pore former is not used in the slurry). The pore former may be a gas, a liquid or a solid. In an embodiment, the pore former is organic and may decompose to liberate a gas when heated to elevated temperatures. Examples of such pore former include solids such as AIBN (azobisisobutyronitrile), which is an organic compound having formula [(CH₃)₂C(CN)]₂N₂. It is a white powder, soluble in alcohols and common organic solvents.

In another embodiment, the pore former may be an organic polymer. The polymer is generally in powdered form and is mixed with the metal oxide (e.g., alumina) powder to form a mixture (or a slurry, if a solvent is also used) that is then disposed in the metal oxide (e.g., alumina) tube. Upon heating the metal oxide (e.g., alumina) tube to temperatures of 300 to 600° C., the polymer decomposes and facilitates the formation of pores in the metal oxide (e.g., alumina) powder.

Organic polymers used in the spaced features and/or the surface can be may be selected from a wide variety of thermoplastic polymers, blend of thermoplastic polymers, thermosetting polymers, or blends of thermoplastic polymers with thermosetting polymers. The organic polymer may also be a blend of polymers, copolymers, terpolymers, or combinations comprising at least one of the foregoing organic polymers. The organic polymer can also be an oligomer, a homopolymer, a copolymer, a block copolymer, an alternating block copolymer, a random polymer, a random copolymer, a random block copolymer, a graft copolymer, a star block copolymer, a dendrimer, a polyelectrolyte (polymers that have some repeat groups that contain electrolytes), a polyampholyte (a polyelectrolyte having both cationic and anionic repeat groups), an ionomer, or the like, or a combination comprising at last one of the foregoing organic polymers. The organic polymers have number average molecular weights greater than 10,000 grams per mole, preferably greater than 20,000 g/mole and more preferably greater than 50,000 g/mole.

Exemplary organic polymers include polyacetals, polyacrylics, polycarbonates, poly(meth)acrylates, polyalkyds, polystyrenes, polyolefins, polyesters, polyamides, polyaramides, polyamideimides, polyarylates, polyurethanes, epoxies, phenolics, silicones, polyarylsulfones, polyethersulfones, polyphenylene sulfides, polysulfones, polyimides, polyetherimides, polytetrafluoroethylenes, polyetherketones, polyether ether ketones, polyether ketone ketones, polybenzoxazoles, polyoxadiazoles, polybenzothiazinophenothiazines, polybenzothiazoles, polypyrazinoquinoxalines, polypyromellitimides, polyguinoxalines, polybenzimidazoles, polyoxindoles, polyoxoisoindolines, polydioxoisoindolines, polytriazines, polypyridazines, polypiperazines, polypyridines, polypiperidines, polytriazoles, polypyrazoles, polycarboranes, polyoxabicyclononanes, polydibenzofurans, polyphthalides, polyacetals, polyanhydrides, polyvinyl ethers, polyvinyl thioethers, polyvinyl alcohols, polyvinyl ketones, polyvinyl halides, polyvinyl nitriles, polyvinyl esters, polysulfonates, polysulfides, polythioesters, polysulfones, polysulfonamides, polyureas, polyphosphazenes, polysilazanes, polypropylenes, polyethylenes, polyethylene terephthalates, polyvinylidene fluorides, polysiloxanes, or the like, or a combination thereof.

In another embodiment, the pore former may be a gas that is soluble in the metal oxide (e.g., alumina) powder or in the solvent used in the slurry. The gas may then phase separate (upon changing the pressure and/or temperature) from the slurry (due to binodal decomposition) to form a porous phase (which are the pores) in the slurry. Examples of such gases include carbon dioxide, argon, hydrogen, nitrogen, or combinations thereof.

In yet another embodiment, a blowing agent such as a chlorofluorocarbons, hydro-chlorofluorocarbons (HCFCs), and/or hydrofluorocarbons (HFCs) may be used to form the pores. Chlorofluorocarbons (CFCs) are derived from methane and ethane and these compounds have the formulae CClₘF₄₋ₘ and C₂ClₘF₆₋ₘ, where m is nonzero. Hydro-chlorofluorocarbons (HCFCs) are also derived from methane and ethane these compounds have the formula CClₘFₙH₄₋ₘ₋ₙ and C₂ClₓF_{y}H_{6-x-y}, where m, n, x, and y are nonzero. Hydrofluorocarbons (HFCs) may also be derived from methane, ethane, propane, and butane, these comp1ounds have the respective formulae CFₘH₄₋ₘ, C₂FₘH₆₋ₘ, C₃FₘH₈₋ₘ, and C₄FₘH₁₀₋ₘ, where m is nonzero.

The pore former may also be used in amounts of 5 to 50 wt%, preferably 10 to 25 wt%, based on the total weight of the slurry. Combinations of the foregoing pore formers may be also be used.

The slurry is prepared by mixing the metal oxide powder (e.g., alumina powder), the optional solvent and the pore former. The slurry is then introduced into the hollow center of the metal oxide tube. The slurry may or may not be compacted.

The metal oxide (e.g., alumina) tube with the slurry contained therein is subjected to a temperature of 300 and 600° C. for a period of 10 minutes to 12 hours to form the pores in the core of the metal oxide tube. This step facilitates the activation of the pore former. The elevated temperature causes the pore former to decompose and liberate gases which facilitate the pore formation in the core of the metal oxide (e.g., alumina) tube.

The metal oxide (e.g., alumina) tube with the porous metal oxide contained therein is then subjected to one or more sintering steps. In an embodiment, a first sintering step is performed at temperatures of 800 to 1600° C., in air or in a controlled atmosphere. This first sintering step is optional and is performed to enhance handleability (i.e., ensuring that the porous core remains intact within high density metal oxide shell). The first sintering step is performed in either, vacuum, air, oxygen, argon, nitrogen, natural gas, hydrogen, carbon dioxide, or a combination thereof in vacuum, atmospheric pressure and/or in a controlled pressure environment where the pressure is greater than atmospheric pressure.

The metal oxide tube with the porous core is then subjected to a second sintering step performed at temperatures of 1500 and 2000° C. in either, vacuum, air, oxygen, argon, nitrogen, natural gas, hydrogen, carbon dioxide, or a combination thereof to yield a metal oxide disc with the porous center. The porous center comprises open cell pores which permit a gas to flow through the metal oxide disc from one end to another.

In an embodiment, a method for manufacturing the metal oxide disc comprises disposing into a dense outer tube a metal oxide powder. No pore former and/or solvent is used in the powder. The dense outer tube with the metal oxide powder disposed therein is sintered to a temperature of 800 to 2000° C. in one or more steps. The two-step sintering process detailed above may also be used here. This creates a porous core in the dense outer tube. This creates a porous core in the dense outer tube that has a purity of greater than 99%. Both the porous core and the dense outer tube have a porosity of greater than 99%.

In both of the sintering methods disclosed above, the porous core has a higher purity than the dense outer tube. This applies to all ceramic discs.

The sintered metal oxide disc is now a dual-density part having a first higher density shell and a second lower density core. The part then may or may not be subjected to further finishing operations. The metal oxide shell density is greater than that of the porous metal oxide core. In an embodiment, the finishing operation can involve slicing the disc into several smaller discs. In another embodiment, the metal oxide disc can have features such as, a radius at an edge, a step or a chamfer (or multiple chamfers) that can be machined into the shell, before formation of porous (within) or after the formation of the pores. The porous portion within the outer metal oxide shell can be made flush with the shell wall by machining that includes milling. The outer diameter can be ground to meet desired dimensions. Machining can be performed by using a water-soluble coolant to wash out any remnant post-machining impurity to ensure high purity of the parts.

The dual density metal oxide disc permit fluid to flow from one side to the other and can be used as flow controllers and filters, made to various pore sizes distributions. High crush strength because of dense metal oxide shell and high flow because of porous (formed without compaction) within the shell is a key characteristic of the dual-density parts. Pore size is greater than 0.5 micrometer and can be controlled for flow control and filtration applications. A strong bond (via covalent bonding and/or ionic bonding) between porous metal oxide and the metal oxide tube (shell) is created during the sintering process.

The dual-density metal oxide discs adhere to cleanliness standards set forth by the semiconductor industry. This is witnessed by the low particulate shedding under exposure to sonication in de-ionized water. Crush strength of dual-density metal oxide disc can exceed 20,000 pounds per square inch and crush strength of porous portion can exceed 2000 pounds per square inch when tested as detailed below. The crush strength and flow of the gases within the pores depend on the initial particle size distribution of the metal oxide powder used, the amount (i.e., weight percent) of pore former in the blend and the sintering conditions. Additionally, flow increases with increase in inner diameter and decrease in length of the metal oxide disc. Flow rate, crush strength (of the porous region within the dense shell) and density data of the dual-density disc obtained using different blend compositions is shown in Table 1 below. The Table 1 contains exemplary data from samples that were tested. The flow rate was determined at a gauge pressure of 30 pounds per square inch.

TABLE 1

| | | | |
|---|---|---|---|
| Blend composition (% denote weight percentage) | N₂ Flow rate (SCCM), 30 PSI gauge pressure | Density (g/cc) | Crush Strength* of porous within shell (PSI) |
| 85% alumina powder, and 15% pore former | 10,000 to 15,000 | 1.2 to 1.5 | 2000 to 6000 |
| 80% alumina powder, and 20% pore former | 15,000 to 20,000 | 1.1 to 1.4 | 2000 to 5000 |
| 75% alumina powder, and 25% pore former | 15,000 to 22,000 | 1.0 to 1.3 | 2000 to 4000 |

The Table 1 shown the composition of matter of the porous center after sintering. The flow rate through the metal oxide disc can vary over a broad range depending on the application. It can be seen that the nitrogen flow rate through the metal oxide disc varies from 5,000 to 30,000 standard cubic centimeters per minute, preferably 10,000 to 22,000 standard cubic centimeters per minute. The bulk density of the porous core varies from 1.00 to 2.50 g/cc, preferably 1.05 to 1.30 g/cc, preferably 1.08 to 1.27 g/cc and the crush strength is 1800 to 2500 pounds per square inch within the metal oxide disc. In an embodiment, the porous core has a bulk density of 1.00 to 1.30 g/cc and the crush strength is greater than 2000 pounds per square inch when present within the dense outer tube.

The porous core has a porosity greater than 30 volume percent, preferably greater than 50 volume percent, preferably greater than 70 volume percent, preferably greater than 80 volume percent, and more preferably greater than 90 volume percent, based on the total volume of the core. The ceramic disc also displays radial hermiticity, i.e., it does not leak from the sides of the porous body when a fluid is transported through it. It therefore permits flow in only a longitudinal direction (in the length L direction (see FIG. 1(A)).

Following the production of the porous core (and either before or after the finishing operation), the threads may be machined at opposing ends of the disc (e.g., the sleeve).

The disc with the threads disposed on its inner surface may then be used in the appropriate equipment.

### TEST METHODS

### Porous Crush Strength Test

In order to access the crush strength of the porous core, a method was developed to independently apply force solely to the porous core as opposed to applying force on both on the porous core and dense shell. This method involves fixturing the part in an apparatus that allows for a gauge pin, with a diameter equivalent to the diameter of the porous core, to rest perpendicular to the surface of the porous core. The opening on this fixture that accommodates the gauge pin is made to be 0.005 inches wider than the diameter of the gauge pin so as to minimize frictional forces. The part is fixtured in this apparatus such that the shell is pinned to a surface inside the apparatus and cannot be displaced whereas the porous can be displaced given enough load.

To test the crush strength, the part is placed into the apparatus and loaded onto an MTS or an Instron compressive strength testing machine. The fixture is placed onto a flat, fixed bottom plate. The gauge pin is loaded into the top of the fixture. A flat, upper plate is then set to displace downwards at a rate of 0.001 inch/second, applying a load onto the gauge pin, which then applies a load onto the part. Part failure is recorded by the machine and is manually/visually characterized by two failure methods. The first failure method involves the porous pushing out of the shell. The second failure mode involves crushing the porous material. Whatever failure mode happens first, the load at this failure mode is translated into the compressive strength.

### Density Determination Test

Shell: The shell’s outer diameter and length is dimensioned via use of a drop gauge. The inner diameter is measured via imaging and analysis. Mass is recorded via use of an analytical balance. Density is recorded as the measured mass divided by the calculated volume.

Porous Core: The mass before and after processing the porous is taken. The differential between the measured mass of only the shell and the measured mass of the finished part (with shell and porous core) translates to the mass of the porous core. The dimensions of the porous core are taken. A drop gauge measures the length of the porous core and optical imaging yields the diameter. Density is taken as the differential mass divided by the calculated volume.

Shell + Porous: Finished part is dimensioned by drop gauge. Mass is recorded via analytical balance. Density of the bulk part is calculated as the measured mass over the calculated volume.

While the disclosure has been described with reference to some embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from essential scope thereof. Therefore, it is intended that the disclosure not be limited to the particular embodiments disclosed as the best mode contemplated for carrying out this disclosure, but that the disclosure will include all embodiments falling within the scope of the appended claims.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

All ranges disclosed herein are inclusive of the endpoints, and the endpoints are independently combinable with each other (e.g., ranges of “up to 25 wt.%, or, more specifically, 5 wt.% to 20 wt.%”, is inclusive of the endpoints and all intermediate values of the ranges of “5 wt.% to 25 wt.%,” etc.). “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity and are to be construed to cover both the singular and the plural, unless otherwise indicated herein or clearly contradicted by context. “Or” means “and/or” unless clearly stated otherwise. Reference throughout the specification to “some embodiments”, “an embodiment”, and so forth, means that a particular element described in connection with the embodiment is included in at least one embodiment described herein, and may or may not be present in other embodiments. In addition, it is to be understood that the described elements may be combined in any suitable manner in the various embodiments. A “combination thereof” is open and includes any combination comprising at least one of the listed components or properties optionally together with a like or equivalent component or property not listed.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

Unless specified to the contrary herein, all test standards are the most recent standard in effect as of the filing date of this application, or, if priority is claimed, the filing date of the earliest priority application in which the test standard appears.

Although the discs, assemblies and methods of the present disclosure have been described with reference to exemplary embodiments thereof, the present disclosure is not limited to such exemplary embodiments and/or implementations. Rather, the discs, assemblies and methods of the present disclosure are susceptible to many implementations and applications, as will be readily apparent to persons skilled in the art from the disclosure hereof. The present disclosure expressly encompasses such modifications, enhancements and/or variations of the disclosed embodiments. Since many changes could be made in the above construction and many widely different embodiments of this disclosure could be made without departing from the scope thereof, it is intended that all matter contained in the drawings and specification shall be interpreted as illustrative and not in a limiting sense. Additional modifications, changes, and substitutions are intended in the foregoing disclosure. Accordingly, it is appropriate that the appended claims be construed broadly and in a manner consistent with the scope of the disclosure.

What is claimed is:

1. A dual density disc comprising:
a dense outer tube comprising a metal oxide having a purity of greater than 92%; and
a porous core comprising a metal oxide of a lower density than a density of the dense outer tube; wherein the porous core has a metal oxide purity of greater than 99%; where the dense outer tube has an inner tapered surface.

2. The dual density disc of claim 1, wherein the porous core has a bulk density of 1.00 to 3.0 g/cc and the crush strength is greater than 2000 pounds per square inch when present within the dense outer tube.

3. The dual density disc of claim 1, where the porous core contacts the dense outer tube at its inner surface and where the dense outer tube is in continuous contact with the porous core along an entire circumference of the porous core.

4. The dual density disc of claim 1, having radial hermiticity, which does not leak from the sides of the porous body and permits flow in only a longitudinal direction.

5. The dual density disc of claim 1, wherein the dense outer tube has an outer diameter of 1 to 75 millimeters and an inner diameter of 0.8 to 70 millimeters.

6. The dual density disc of claim 1, wherein the dense outer tube has an initial length of 1 to 120 millimeters.

7. The dual density disc of claim 1, wherein the porous core is manufactured from a metal oxide powder having an initial purity of greater than 92%.

8. The dual density disc of claim 1, wherein the porous core is manufactured from a metal oxide powder having an initial purity of greater than 99%.

9. The dual density disc of claim 1, wherein the porous core is manufactured from a metal oxide powder having an initial purity of greater than 99.5%.

10. The dual density disc of claim 1, where the metal oxide used in the dense outer tube is alumina.

11. The dual density disc of claim 1, where the metal oxide used in the porous core is alumina.

12. The dual density disc of claim 1, where the inner threaded surface is located at an inlet, an outlet of the tube or both at the inlet and the outlet of the tube.

13. The dual density disc of claim 1, where an inlet, outlet or both an inlet and an outlet of the dual density disc has threads on the tapered surface.

14. The dual density disc of claim 1, where an inlet, outlet or both an inlet and an outlet of the dual density disc has a diameter that is greater than a diameter of the porous core.

15. The dual density disc of claim 1, where an inlet, outlet or both an inlet and an outlet of the dual density disc has a diameter that is smaller than a diameter of the porous core.

16. A method comprising:
disposing in a dense outer tube a slurry comprising:
a metal oxide powder and a pore former;
heating the dense outer tube with the slurry disposed therein to a temperature of 300 to 600° C. to activate the pore former;
creating a porous core in the dense outer tube;
sintering the dense outer tube with the porous core at a temperature of 800 to 2000° C. in one or more steps; and
machining threads on an inner surface of the dense outer tube, where the threads are parallel to a longitudinal axis of the tube or inclined to the longitudinal axis of the tube.

17. The method of claim 16, where the sintering operation is performed in air, nitrogen, natural gas, argon, hydrogen, or a combination thereof.

18. The method of claim 16, where the pore former is an organic pore former.

19. The method of claim 16, where the slurry further comprises a solvent.

20. The method of claim 16, wherein the sintering is preceded by a first sintering step where the temperature is 1200 to 1600° C.

21. The method of claim 16, where the pore former is azobisisobutyronitrile.

22. The method of claim 16, where the pore former is gas that is soluble in the metal oxide slurry.

23. The method of claim 16, where the pore former is a liquid.

24. The method of claim 16, wherein the pore former is an organic polymer.

25. The method of claim 24, wherein the organic polymer is a polyacetal, a polyacrylic, a polycarbonate, a poly(meth)acrylate, a polyalkyd, a polystyrene, a polyolefin, a polyester, a polyamide, a polyaramide, a polyamideimide, a polyarylate, a polyurethane, an epoxy, a phenolic, a polyarylsulfone, a polyethersulfone, a polyphenylene sulfide, a polyimide, a polyetherimide, a polytetrafluoroethylene, a polyetherketone, a polyether ether ketone, a polyether ketone, a polybenzoxazole, a polyoxadiazole, a polybenzothiazinophenothiazine, a polybenzothiazole, a polypyrazinoquinoxaline, a polypyromellitimide, a polyguinoxaline, a polybenzimidazole, a polyoxindole, a polyoxoisoindoline, a polydioxoisoindoline, a polytriazine, a polypyridazine, a polypiperazine, a polypyridine, a polypiperidine, a polytriazole, a polypyrazole, a polycarborane, a polyoxabicyclononane, a polydibenzofuran, a polyphthalide, a polyacetal, a polyanhydride, a polyvinyl ether, a polyvinyl thioether, a polyvinyl alcohol, a polyvinyl ketone, a polyvinyl halide, a polyvinyl nitrile, a polyvinyl ester, a polysulfonate, a polysulfide, a polythioester, a polysulfone, a polysulfonamide, a polyurea, a polyphosphazene, a polysilazane, a polyvinylidene fluoride, a polysiloxane, or a combination thereof.

26. A method comprising:
disposing into a dense outer tube an alumina powder; where the alumina powder does not contain a pore former;
sintering the dense outer tube with the alumina powder disposed therein to a temperature of 800 to 2000° C.;
creating a porous core in the dense outer tube; where the porous core has a purity of greater than 99%; and
machining threads on an inner surface of the dense outer tube; where the threads are parallel to a longitudinal axis of the tube or inclined to the longitudinal axis of the tube.

27. The method of claim 26, further comprising heating the dense outer tube with the alumina powder disposed therein to a temperature of 1200 to 1600° C.

28. A dual density disc comprising:
a dense outer tube comprising a first ceramic having a purity of greater than 92%;
a porous core comprising a second ceramic of a lower density than a density of the dense outer tube; wherein the porous core has a purity of greater than 99%; and
wherein the dense outer tube comprises threads on an inner surface of the dense outer tube; where the threads are parallel to a longitudinal axis of the tube or inclined to the longitudinal axis of the tube.

29. The dual density disc of claim 28, wherein the first ceramic is the same as the second ceramic.

30. The dual density disc of claim 28, wherein the first ceramic is different from the second ceramic.
